(19) United States
(12) Patent Application Publication
(10) Pub. No.: US 2012/0315485 A1
(43) Pub. Date: Dec. 13, 2012

(54) HIGH REFRACTIVE INDEX AQUEOUS POLYURETHANE DISPERSION COATING COMPOSITIONS

(75) Inventors: Masanori Iwazumi, Irvine, CA (US); Andreas Schneider, Fullerton, CA (US)

(73) Assignee: SDC Technologies, Inc., Irvine, CA (US)

(21) Appl. No.: 13/580,012

(22) PCT Filed: Jun. 23, 2011
(86) PCT No.: PCT/US11/41602

§ 371 Date: Aug. 20, 2012

Related U.S. Application Data
(60) Provisional application No. 61/358,038, filed on Jun. 24, 2010.

(51) Int. Cl. C09D 175/12; B05D 5/06; B32B 27/08; C08K 3/20; B32B 27/40

(52) U.S. Cl. 428/412; 524/590; 524/591; 524/538; 428/423.1; 428/423.3; 428/424.4; 428/424.6; 428/423.7; 427/164

(57) ABSTRACT

High refractive index aqueous polyurethane dispersion primer coating compositions that provide transparent, impact-resistant, and adhesive primer coatings when applied and cured on a substrate, are provided herein. These polyurethane coating compositions coating compositions comprise a polyurethane polymer having aromatic functional groups in an amount ranging from about 16% to about 42% by weight of the solids of the polyurethane polymer and provide primer coatings having a refractive index ranging from about 1.53 to about 1.63. Processes for making such high refractive index coating compositions; processes for coating substrates with such high refractive index coating compositions; and articles coated with such high refractive index coating compositions are also provided herein.

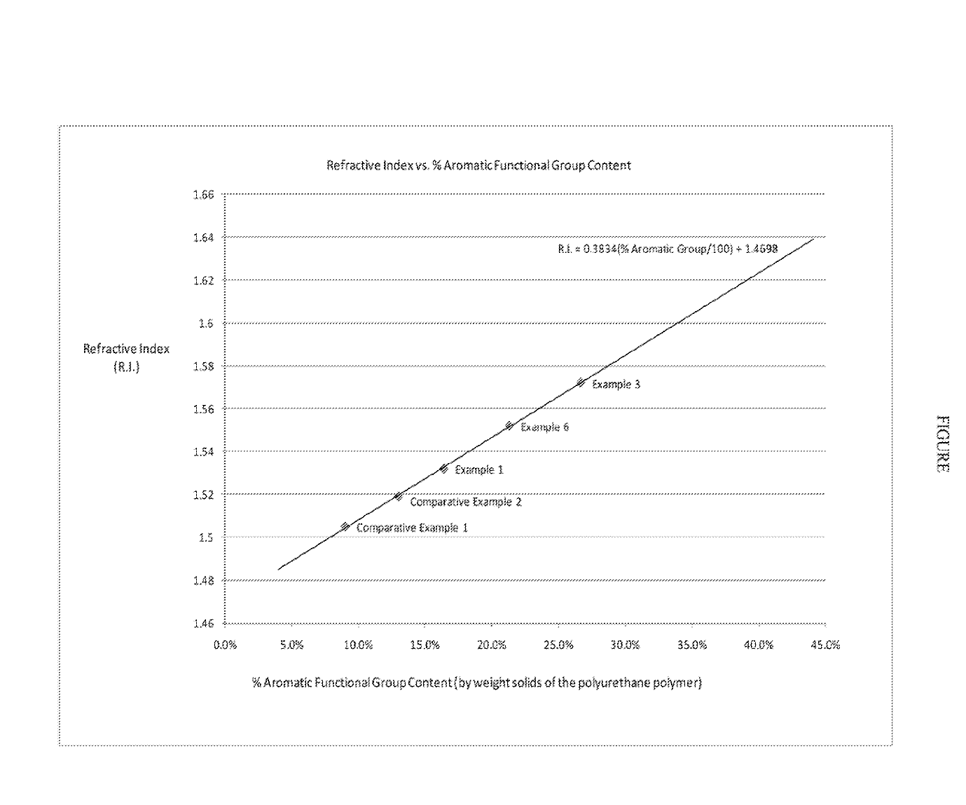

### CROSS-REFERENCE TO RELATED APPLICATION

This application claims priority to and any other benefit of U.S. Provisional Patent Application Ser. No. 61/358,038, filed on Jun. 24, 2010, and entitled “HIGH REFRACTIVE INDEX AQUEOUS POLYURETHANE DISPERSION COATING COMPOSITIONS,” the entire disclosure of which is incorporated by reference herein.

### FIELD OF THE INVENTION

The present invention relates to high refractive index coating compositions. More particularly, the present invention relates to aqueous polyurethane dispersion coating compositions that provide transparent, impact-resistant, adhesive, and high refractive index primer coatings when cured on a substrate. The present invention also relates to processes for making the high refractive index aqueous polyurethane dispersion coating compositions. In addition, the present invention relates to processes for coating substrates with the high refractive index polyurethane coating compositions, and articles coated with such coating compositions.

### BACKGROUND

Primer coatings are useful to improve the impact resistance and adhesion on clear, transparent plastic substrates, such as transparent plastic substrates used as ophthalmic lenses, safety glasses, sport and military goggles, face shields, visors, windows, windshields, and the like. As clear, transparent plastic materials are substituted for glass in many applications because of the favorable properties of the plastic materials, such as high refractive index, light weight, and formability, the transparent plastic materials also have drawbacks. One particular drawback is that the transparent plastic substrates are often soft and tend to scratch or abrade quite easily. To prevent scratching, transparent plastic substrates can be coated with an abrasion-resistant “hard” coat consisting of an organosiloxane coating applied over the substrate, i.e., a hard abrasion-resistant “top” coat. However, while abrasion resistance may improve due to the hard coat, the addition of the hard coat may undesirably reduce the impact resistance of the transparent plastic substrate compared to a corresponding non-hard coated transparent plastic substrate. This can be a significant drawback for transparent plastic substrates used in ophthamalic applications, where as the refractive index increases, the thickness of the lens required to achieve the same level of correction decreases, resulting in a thinner and lighter lens more susceptible to damage from impact. To improve the impact resistance of plastic substrates coated with a hard coat, an elastomeric polymer resin, such as a polyurethane coating, can be used as a primer layer between the transparent plastic substrate and the abrasion resistant hard coat. The polyurethane primer coating acts to absorb energy from impact to the hard coat and prevent shattering or cracks from propagating from the hard coat into the transparent plastic substrate.

In addition to improving impact resistance of transparent plastic substrates, polyurethane primer coatings are also useful as an adhesive layer. Many different types of coatings or additive layers can be applied to a substrate that do not readily adhere to the surface of the substrate. In such instances, a polyurethane primer coating is applied to form layer on the substrate more readily adhered to by the other coatings or layers.

Further benefits for polyurethane primer coatings can be realized by an aqueous polyurethane dispersion. Aqueous polyurethane dispersion coating compositions are more stable and have a longer shelf-life than their reactive two-component polyurethane system counterparts. The relative instability of the two-component system results from the need to apply the two component system to the substrate soon after mixing as the system reacts and begins curing upon mixing. In contrast, the aqueous polyurethane dispersion can be stored for an extended period of time, i.e., weeks or months, before it is applied to a substrate and begins curing. The stability and, consequently, the shelf-life of the reactive two-component polyurethane system can be improved by using a suitable blocked isocyanate as one component of the system. However, a two-component system using a blocked isocyanate requires heat to initiate curing, thus adding additional complexity and costs to the two-component system coating process, in contrast to an aqueous polyurethane dispersion coating composition which cures at ambient temperature by air-drying and does not require heat to initiate or sustain curing.

Another benefit of the aqueous polyurethane dispersions is that they are less hazardous than the reactive two-component polyurethane systems because water is the primary solvent in the aqueous dispersion, rather than the organic solvents that may have high volatile organic component (VOC) concentrations.

One drawback of aqueous polyurethane dispersion coating compositions, however, is that the polyurethane primer coatings formed from aqueous dispersions may cause interference with light passing through the coated substrate if the refractive index of the polyurethane primer coating significantly differs from the refractive index of the transparent substrate.

The path of light waves bends when passing from one medium to another, which is due to the reduction of the speed of light across the different mediums. A measure of the amount of the bend in the path of the light is called the refractive index. In the context of a particular medium, the refractive index can be expressed as the ratio of the speed of light in a vacuum to the speed of light in the medium. Therefore, different mediums each have a respective refractive index value. A transparent substrate has one refractive index value and a coating applied to the substrate can have a different refractive index value. For a substrate and a coating that have different refractive index values, as the difference in values between the refractive index for the transparent substrate and the coating increases, the optical clarity through the coated substrate will suffer because of light wave interference resulting from these two mediums having different refractive qualities. Conversely, as the difference between the refractive index of the substrate and the refractive index of the coating decreases, the optical clarity improves because of a decrease in light wave interference.

As used herein, materials that are considered to have a high refractive index are materials that have respective refractive indices with values greater than or equal to about 1.53. As the use of high refractive index plastics have increased in applications in which polyurethane primers are useful, the refractive indices of other coatings or layers applied to the substrate must also increase so as to not cause interference of the light passing through the coated or layered high refractive index substrates. Described herein are aqueous polyurethane dispersion coating compositions, when applied to a substrate and cured, provide transparent, impact-resistant, and adhesive polyurethane primer coatings having a high refractive index ranging from about 1.53 to about 1.63.

### SUMMARY

In accordance with the embodiments of this invention, high refractive index aqueous polyurethane dispersion primer coating compositions that provide transparent, impact-resistant, and adhesive primer coatings when applied and cured on a substrate, are described herein.

In one embodiment, the coating composition comprises a polyurethane polymer having aromatic functional groups in an amount ranging from about 16% to about 42% by weight of the solids of the polyurethane polymer, wherein the polyurethane polymer comprises the reaction products of an aromatic diisocyanate; at least one active hydrogen compound selected from the group consisting of: i) an aliphatic diol having from about 2 to about 8 carbons, ii) an aromatic diol, iii) a sulfide functional alkyl compound having from about 2 to about 4 carbons, iv) a thiol functional hydrocarbon compound having from about 2 to about 8 carbons, and v) combinations thereof; a dihydroxycarboxylic acid; and a multi-functional amine. The primer coating formed from the coating composition has a refractive index ranging from about 1.53 to about 1.63.

In another embodiment, the coating composition comprises a polyurethane polymer having aromatic functional groups in an amount ranging from about 16% to about 27% by weight of the solids of the polyurethane polymer, wherein the polyurethane polymer comprises the reaction products of an aromatic diisocyanate; at least one active hydrogen compound is selected from the group consisting of an aliphatic diol having from about 2 to about 8 carbons, an aromatic diol, and combinations thereof; a dihydroxycarboxylic acid; and a multi-functional amine. The primer coating formed from the coating composition has a refractive index ranging from about 1.53 to about 1.57.

In another embodiment, the coating composition comprises a polyurethane polymer having aromatic functional groups in an amount ranging from about 16% to about 42% by weight of the solids of the polyurethane polymer and sulfur in an amount ranging from about 0.1% to about 15% by weight of the solids of the polyurethane polymer, wherein the polyurethane polymer comprises the reaction products of an aromatic diisocyanate; at least one active hydrogen compound is selected from the group consisting of a sulfide functional alkyl compound having from about 2 to about 4 carbons, a thiol functional hydrocarbon compound having from about 2 to about 8 carbons, and combinations thereof; a dihydroxycarboxylic acid; and a multi-functional amine. The primer coating formed from the coating composition has a refractive index ranging from about 1.53 to about 1.63.

In another embodiment, the coating composition comprises a polyurethane polymer having aromatic functional groups in an amount ranging from about 16% to about 42% by weight of the solids of the polyurethane polymer, wherein the polyurethane polymer comprises the reaction products of an aromatic diisocyanate; a polymer diol; at least one active hydrogen compound selected from the group consisting of: i) an aliphatic diol having from about 2 to about 8 carbons, ii) an aromatic diol, iii) a sulfide functional alkyl compound having from about 2 to about 4 carbons, iv) a thiol functional hydrocarbon compound having from about 2 to about 8 carbons, and v) combinations thereof; a dihydroxycarboxylic acid; and a multi-functional amine. The primer coating formed from the coating composition has a refractive index ranging from about 1.53 to about 1.63.

The coating compositions described herein further comprise a dispersing agent and an amount of water sufficient to disperse the polyurethane polymer to form an aqueous polyurethane dispersion coating composition upon the neutralization of the polyurethane polymer with the dispersing agent. The coating compositions described herein are dispersed by the neutralization of the carboxylic acid functional group of the polyurethane prepolymer or polymer with a dispersing agent. Also, the coating compositions may further comprise an ultraviolet light absorber.

In accordance with another embodiment, processes of making the high refractive index aqueous polyurethane dispersion coating compositions are provided.

In accordance with other embodiments, processes of coating substrates with the high refractive index aqueous polyurethane dispersion coating compositions described herein and articles coated with such aqueous polyurethane dispersion coating compositions are provided.

### BRIEF DESCRIPTION OF THE DRAWING

The FIGURE is a plot of the refractive index as a function of aromatic functional group content for cured polyurethane coating compositions described herein.

### DETAILED DESCRIPTION

Unless otherwise defined, all technical and scientific terms used herein have the same meaning as commonly understood by one of ordinary skill in the art to which this invention belongs. The terminology used in the description of the invention herein is for describing particular embodiments only and is not intended to be limiting of the invention. The present invention may be embodied in different forms, and the reference to the specific embodiments of this application should not be construed to limit the invention to the embodiments described herein. Rather, these embodiments are provided for thoroughness and completeness of this disclosure.

As used in the description of the invention and the appended claims, the singular forms “a,” “an,” and “the” are intended to include the plural forms as well, unless the context clearly indicates otherwise.

Unless otherwise indicated (i.e., by use of the term “precisely”), all numbers expressing quantities, properties such as molecular weight, reaction conditions, and so forth as used in the specification and claims are to be understood as being modified in all instances by the term “about.” Accordingly, unless otherwise indicated, the numerical properties set forth in the following specification and claims are approximations that may vary depending on the desired properties sought to be obtained in embodiments of the present invention.

As used herein, “high refractive index” refers to a refractive index of greater than or equal to about 1.53. In addition, unless otherwise specifically indicated, the refractive index used herein for coatings or coating compositions refers to the value of the refractive index of the coating that is formed from the coating composition, i.e., the refractive index of the polyurethane polymer primer coating and not the refractive index of the aqueous embodiment of the aqueous polyurethane dispersion coating composition.

The refractive index of a material is a measure of how much the light will refract, i.e., bend, as the light passes from one medium to another. Light waves travel at different speeds through different mediums. As a result of the light waves entering a different medium, the speed of the light changes. Because the frequency of the light does not change across mediums, a change in the speed of the light waves causes the path of the light to bend. The refractive index indicates just how much the light bends. For a particular medium, the refractive index (R.I.) can be expressed as R.I.=[velocity of light in a vacuum/velocity of light in the medium]. The velocity of light in a vacuum does not significantly differ from the velocity of light in air, and therefore, the refractive index can be expressed by substituting the velocity of light in air for the velocity of light in a vacuum. The refraction caused by light passing across different mediums, which correlates with the optical clarity through the mediums, is minimized by minimizing the difference between the refractive index for each medium. Accordingly, to reduce or minimize the refraction for a substrate having a refractive index of greater than or equal to about 1.53, any coating applied to the substrate, such as a polyurethane primer coating, needs to have a similar refractive index to that of the substrate, i.e., greater than or equal to about 1.53, so as to minimize the difference between the respective refractive indices of the substrate and the coating.

It has been determined by the inventors that the refractive properties of an aqueous polyurethane dispersion coating composition improve as the aromatic functional group content of the polyurethane polymer coating formed from the composition increases, i.e., the refractive index increases as the concentration of the aromatic functional groups within the polymer increases. In particular, the inventors have determined the following relationship between the refractive index of the polyurethane and the aromatic functional group content: refractive index=[0.3834*(% aromatic functional group content/100)+1.4698]. The FIGURE illustrates this relationship. To create an effective coating composition using this relationship, the aromatic functional groups are present in an amount ranging from about 16% to about 42% by weight solids of the polyurethane polymer. Otherwise, if the aromatic functional groups are below 16%, the refractive index of the cured coating framed from this coating composition is less than 1.53 and is therefore not high refractive index as defined herein. Conversely, having more than 42% aromatic functional groups affects the dispersibility of the coating composition in water. Accordingly, the high refractive index polyurethane coating compositions described herein comprise aromatic functional groups in an amount ranging from about 16% to about 42% by weight of the polyurethane polymer. These coating compositions provide transparent, impact-resistant, adhesive, and high refractive index primer coatings when applied and cured on a substrate, wherein the primer coatings have a refractive index ranging from about 1.53 to about 1.63.

A polyurethane is a polymer characterized by the occurrence of urethane groups [—NH—C═O—O—] and urea groups [—N—H—(C═O)—NH—] in a macromolecular chain. These groups are generally formed through reactions of compounds having more than one isocyanate functional group with compounds having more than one active hydrogen functional group. An “active hydrogen functional group” as used herein refers to any functional group that readily reacts with an isocyanate functional group, such as a hydroxyl functional group, an amino functional group, and a thiol functional group. Accordingly, an “active hydrogen compound” as used herein refers to any compound or molecule that has at least one active hydrogen functional group, including but not limited to a hydroxyl functional group, an amino functional group, a thiol functional group, or combinations thereof. The urethane groups of the polyurethane are typically formed by polyaddition reactions of polyisocyanates with polyols, although the formation of the urethane groups are not limited to these reactants. Polyisocyanates are molecules with two or more isocyanate functional groups, i.e., R¹—(N═C═O)_{n≧2}. Polyols are molecules with two or more hydroxyl functional groups, i.e., R²—(OH)_{n≧2}. The urea groups are typically framed by polyaddition reactions of polyisocyanates and polyamines. Polyamines are molecules containing two or more amino functional groups, i.e., R³—(NH₂)_{n≧2}.

Aqueous polyurethane dispersion coating compositions are colloidally stable dispersions formed from polyurethane polymers dispersed in a water phase. The preparation of an aqueous polyurethane dispersion can generally be classified as taking place within three steps, although one of ordinary skill in the art would understand that these three steps are not mutually exclusive from each other. Moreover, this specification describes the present invention in the context of these steps for clarity, and the embodiments or features of the present invention should not be construed as being limited to these steps. Furthermore, these three steps should not be construed as being limited to this order, but rather these steps can take place in a different orders, or can take place concurrently, or in combinations thereof.

In general, the three steps include: 1) the polyurethane prepolymer formation step, 2) the dispersion step, and 3) the final polymerization step. The first step generally relates to the creation of a polyurethane prepolymer having isocyanate-terminated end groups through reactions between polyols and excess polyisocyanates in an organic solvent at high temperatures. The formation of the prepolymer is critical to defining the characteristics of the resulting polyurethane polymer, and thus high refractive index properties in accordance with coating compositions described herein are attributable to the formation of the prepolymer.

The second step generally includes the dispersion of the polyurethane prepolymer or polymer into water to form a stable colloidal dispersion. Polyurethane prepolymers or polymers are generally dispersed into the aqueous phase by the aid of a dispersing agent, or alternatively, a dispersing agent and mixing. By reacting the dispersing agent with the polyurethane prepolymer or polymer, the prepolymer or polymer gains water miscible or solvable groups that aid in the formation of stable polyurethane polymer particles dispersed in the water.

The third step in preparing an aqueous polyurethane dispersion is the final polymerization step. The final polymerization step is the extension of the polyurethane polymer chains by reacting the isocyanate-terminated ends of the prepolymer with multi-functional amines or multi-functional alcohols to extend the polyurethane prepolymer to a high molecular weight polymer. As the three steps used to describe this process of preparing an aqueous dispersion are not mutually exclusive of each other, the final polymerization step can take place before, during, or after the dispersion step.

The first step in preparing the aqueous dispersion coating composition is the creation of the polyurethane prepolymer. The polyurethane prepolymer is generally created by reacting polyols with a surplus of the polyisocyanates, i.e., when the stoichiometric ratio of isocyanate functional groups of the polyisocyanates to the hydroxyl functional groups of the polyols is greater than or equal to about 1.1:1. The selection of the polyols and the polyisocyanates determines the composition, and consequently, the properties of the resulting polyurethane polymer formed from the prepolymer. Accordingly, because the high refractive index polyurethane coating compositions described herein have aromatic functional groups in an amount ranging from about 16% to about 42% by weight of the polyurethane, the polyurethane prepolymer is obtained by selecting sufficient amounts of polyisocyanates having aromatic functional groups, polyols having aromatic functional groups, or a combination of selecting both polyisocyanates and polyols having aromatic functional groups.

As described above, a polyisocyanate includes any compound containing two or more isocyanate functional groups. The high refractive index coating compositions described herein use polyisocyanates having two isocyanate functional groups, which are referred to as diisocyanates. To obtain an aromatic functional group content in the polyurethane prepolymer reaction, an aromatic diisocyanate is used. As referred to herein, an aromatic diisocyanate includes any diisocyanate comprising at least one aromatic functional group that carries over into the polyurethane polymer structure from the diisocyanate upon the polyaddition reaction forming the polyurethane prepolymer. Examples of aromatic diisocyanates as used herein include, but are not limited to xylylene diisocyanates (XDI), tetramethylxylene diisocyanates (TMXDI), toluene diisocyanates (TDI), naphthalene diisocyanates (NDI), phenylene diisocyanates, toluidine diisocyanates (TODD, diphenylmethane diisocyanates (MDI), any diisocyanates derived from the foregoing, and combinations thereof. Xylylene diisocyanates, specifically m-xylylene diisocyanates, or tetramethylxylene diisocyanates are preferred aromatic diisocyanates used with the high refractive index primer coating compositions described herein.

In accordance with one embodiment of the high refractive index coating compositions described herein, the selection of the polyols reacting with the aromatic diisocyanates is used to adjust the aromatic functional group content in the polyurethane prepolymer and corresponding polyurethane polymer. Specifically, using short-chain polyols, i.e., hydrocarbon polyols having less than or equal to about 8 carbons in the entire hydrocarbon chain, or less than or equal to 8 carbon atoms in the repeating unit of the hydrocarbon chain, increases the weight percent of the aromatic functional groups in the resulting polyurethane polymer relative to long-chain polyols, i.e., hydrocarbon polyols having more than about 8 carbons in the entire hydrocarbon chain, or more than 8 carbon atoms in the repeating unit of the hydrocarbon chain. The high refractive index coating compositions described herein use polyols having two hydroxyl functional groups, which are referred to as diols. Embodiments of the high refractive index coating compositions described herein use polyols such as polymer diols, aliphatic diols, or combinations of polymer diols and aliphatic diols. As referred to herein, aliphatic diols are hydrocarbon monomer molecules, hydrocarbon oligomer molecules containing four or fewer repeating monomer units in the oligomer molecule, or combinations thereof. Polymer diols, as referred to herein, are hydrocarbon macromolecules containing more than four repeating monomer units in the macromolecule. For example, as used herein, a poly(ethylene) glycol is a polymer diol, and each of an ethylene glycol, a diethylene glycol, and a triethylene glycol are aliphatic diols. Short-chain polymer or aliphatic diols are preferred because the short-chains in the diols result in a shorter distance between the repeating aromatic functional groups in the polyurethane polymer segments attributable to the aromatic diisocyanates. Increasing the frequency of the repeating aromatic functional groups within the polyurethane increases the concentration of the aromatic functional groups and consequently the weight percent of the aromatic functional groups in the overall polyurethane polymer.

The high refractive index polyurethane coating compositions described herein result in a coating having a refractive index ranging from about 1.53 to about 1.63 when the polyurethane comprises from about 16% to about 42% of aromatic functional groups by weight. As is illustrated in Comparative Example 1, using a polymer diol as the only polyol in the prepolymer reaction, particularly a polycarbonate diol with an average molecular weight of about 2000, obtains an aromatic functional group content of about 9% by weight of the solids of the polyurethane. For the reasons discussed above, using short-chain aliphatic diols, in addition to, or in place of, the polymer diols increases the aromatic functional groups content of the polyurethane polymer compared to polyurethane polymers formed from just polymer diols. This is illustrated in Comparative Example 2 below. The introduction of a small amount of short-chain aliphatic diols, relative to the amount of the longer-chain polycarbonate diol used, increases the aromatic functional group content to about 13% by weight of the polyurethane as compared to the 9% aromatic content of the similar polyurethane coating composition described in Comparative Example 1. The distance between the repeating aromatic functional group units in the polyurethane polymer decreases in at least some segments of the polyurethane attributable to the aliphatic diols when both aliphatic diols and polymer diols are used, thereby increasing the content of aromatic functional groups in the overall polyurethane polymer. Therefore, to obtain an aromatic functional group content ranging from about 16% to about 42% by weight of the solids of the polyurethane polymer, in accordance with the coating compositions described herein, a short-chain aliphatic diol or a combination of sufficient amounts of a polymer diol and a short-chain aliphatic diol are used as active hydrogen compounds in the prepolymer reaction.

Examples of polymer diols used to form the high refractive index polyurethane coating compositions include polycarbonate diols, polyether diols, polyester diols, polyhydric alcohols, alkoxylated diols, amide-containing diols, polyacrylic diols, epoxy diols, polyhydric polyvinyl alcohols, or mixtures of any of the aforementioned polymer diols. Examples of more specific suitable polymer diols are poly(hexamethylene carbonate) diols having an average molecular weight ranging from about 800 to about 2000. The polymer diols used herein to form the high refractive index polyurethane coating composition also include aromatic polymer diols, i.e., arylated polymer diols having at least one aromatic functional group. Examples of such aromatic polymers include polycarbonate diols formed from bisphenol A compounds.

Examples of suitable short-chain aliphatic diols used with the coating compositions described herein include aliphatic diols having hydrocarbon chains from about 2 to about 8 carbons, preferably from about 2 to about 3 carbons. Such short-chain aliphatic diols include alkylene glycols having from about 2 to about 8 carbons, preferably alkylene glycols having from about 2 to about 3 carbons. Specific examples of short-chain aliphatic diols suitable for the high refractive index coating compositions herein include ethylene glycol, diethylene glycol, triethylene glycol, propylene glycol, butanediol, pentanediol, hexanediol, heptanediol, octanediol, and any of the derivatives thereof, preferably ethylene glycol and propylene glycol. In accordance with one embodiment of the high refractive index coating compositions described herein, preferred polyols used as active hydrogen compounds to form the polyurethane prepolymer comprise an aliphatic diol having from about 2 to about 8 carbons and a polymer diol. The aromatic functional group content of the polyurethane polymer formed from the aliphatic diol having from about 2 to about 8 carbons and the polymer diol ranges from about 16% to about 27% by weight of the solids of the polyurethane polymer. The refractive index of the corresponding polyurethane polymer coating formed from the aliphatic diol and the polymer diol ranges from about 1.53 to about 1.57.

In accordance with another embodiment, the concentration of the aromatic functional groups in the polyurethane prepolymer and corresponding polymer is adjustable by selecting aromatic diols to react with aromatic diisocyanates in the prepolymer reaction. As referred to herein, an aromatic diol includes any diol comprising at least one aromatic functional group that carries over into the polyurethane polymer structure from the diol during the polyaddition reaction forming the polyurethane prepolymer. When these diols having at least one aromatic functional group are reacted with aromatic diisocyanates, the use of the aromatic diols increases the frequency of the repeating aromatic functional group units over other short-chain polymer or short-chain aliphatic diols that do not contain aromatic functional groups because aromatic functional groups are found in the polyurethane polymer segments attributable to both the aromatic diisocyanates and the aromatic diols.

Examples of aromatic diols include benzenediol compounds such as catechols, hydroquinones, xylylene diols, resorcinols, methylresorcinols, alkyl-substituted benzenes diols, alkoxy-substituted benzenes diols, xylene diols; bisphenol A compounds, including but not limited to bisphenol A alkoxylates; and derivatives thereof. Suitable aromatic diols for use with the coating compositions described herein include aromatic diol compounds having from about 2 to about 8 carbons in the compound and bisphenol A alkoxylates having about 2 to about 4 carbons in the alkoxylate chains. Preferred for use herein are bisphenol A alkoxylates having about 2 to about 4 carbons in the alkoxylate chains, more preferably bisphenol A alkoxylates having about 2 to about 3 carbons in the alkoxylate chain. Specific examples of bisphenol A alkoxylates include bisphenol A ethoxylate, bisphenol A propoxylate, and bisphenol A butoxylate. In accordance with one embodiment of the high refractive index coating compositions described herein, polyols used as active hydrogen compounds to form the polyurethane prepolymer comprise a polymer diol and an aromatic diol. The resulting aromatic functional group content of the polyurethane polymer formed from the polymer diol and the aromatic diol ranges from about 16% to about 27% by weight of the solids of the polyurethane polymer. The refractive index of the corresponding polyurethane polymer coating formed from the polymer diol and the aromatic diol ranges from about 1.53 to about 1.57.

In accordance with another embodiment, short-chain aliphatic diols, aromatic diols, or combinations thereof, are used to react with the aromatic diisocyanates to form the polyurethane prepolymer and corresponding polymer of the coating composition. An example of this embodiment is a polyurethane polymer formed using at least one of a short-chain aliphatic diol, an aromatic diol, or combinations thereof. The polyurethane polymer formed from the coating composition in accordance with this embodiment has aromatic functional groups in an amount ranging from about 16% to about 27% by weight of the solids of the polyurethane polymer, and the polyurethane polymer coating has a refractive index ranging from about 1.53 to about 1.57. Preferred short-chain aliphatic diols used in accordance with this embodiment include alkylene glycols having from about 2 to about 3 carbons in the hydrocarbon chain. Preferred aromatic diols used in accordance with this embodiment include bisphenol A alkoxylates having about 2 to about 3 carbons in the alkoxylate chain.

In addition to adjusting the refractive index properties by adjusting the aromatic functional group content of the polyurethane polymer, the refractive index properties are adjusted by forming the polyurethane polymer using a sulfide functional alkyl compound having from about 2 to about 4 carbons in the alkyl chain or a thiol functional hydrocarbon compound having from about 2 to about 8 carbons in the compound, thereby creating a polyurethane polymer having aromatic functional groups and sulfur. Preferably, the thiol functional hydrocarbon compound has from about 2 to about 4 carbons in the compound. In accordance with this embodiment, the sulfide functional alkyl compounds, the thiol functional hydrocarbon compounds, or combinations thereof are used instead of, or in combination with, the diols used to form the polyurethane polymer. As referred to herein, the sulfide functional alkyl compounds and the thiol functional hydrocarbon compounds each have greater than or equal to two active hydrogen functional groups, i.e., at least two isocyanate functional group reactive sites. The sulfide functional alkyl compounds include compounds having at least one sulfide functional group. Examples of such sulfide alkyl functional compounds include thioethers such as thiodiglycols or sulfide functional alkyl dithiols. Specific examples of the sulfide functional alkyl compound used herein includes bis(2-hydroxyethyl) sulfide, 2,5-dimethyl-1,4-dithiane, and bis(2-mercaptoethyl)sulfide.

The thiol functional hydrocarbon compound used herein includes thiol functional alkyl or aryl hydrocarbon compounds having at least one thiol functional group and at least one other active hydrogen functional group. Examples of such hydrocarbon compounds are a mercapto alkyl alcohol, i.e., a compound having one thiol functional group and one hydroxyl functional group, and compounds having more than one thiol functional group, i.e., alkyl dithiols. More particularly, suitable thiol functional hydrocarbon compounds include mercapto alkyl alcohols having from about 2 to about 8 carbons in the alkyl chain, such as 2-mercaptoethanol or 3-mercapto-1-propanol; alkyl dithiols having from about 2 to about 8 carbons in the alkyl chain, such as ethanedithiol, propanedithiol, 1,2-dimercaptopropane, 1,2-ethanedithiol, 2-mercaptoethyl ether, and 1,3-propanedithiol; thiol functional aryl compounds having from about 2 to about 8 carbons in the compound, such as benzene-1,2-dithiol, 1,4-benzenedimethanethiol; or combinations thereof. In accordance with this embodiment, a polyurethane polymer formed by reacting aromatic diisocyanates with at least one of: a sulfide functional alkyl compound having from about 2 to about 4 carbons, a thiol functional hydrocarbon compound having from about 2 to about 8 carbons, or combinations thereof comprises from about 16% to about 42% aromatic functional groups and from about 0.1% to about 15% sulfur by weight of the solids of the polyurethane polymer. The resulting polyurethane polymer coating has a refractive index ranging from about 1.53 to about 1.63.

In accordance with another embodiment, additives such as ultraviolet (UV) absorbers can be added to the polyurethane prepolymer mixture before the prepolymer is dispersed in water. The UV light absorbers become trapped within the polyurethane polymer structure as the polyurethane is dispersed in water. The UV light absorbers enhance both the UV stability of the polyurethane coating formed in accordance with the coating compositions described herein and also enhance the refractive index of these coatings. Adding a UV absorber enhances the refractive index of the coatings because UV light absorbers contain aromatic functional groups, which further add to the aromatic functional group content of the polyurethane polymer. Accordingly, suitable UV absorbers used herein include UV absorbers having at least one aromatic functional group, such as compounds based on benzophenone or benzotriazole UV absorbers. The UV absorbers comprise from 0 to about 12% by weight of the solids of the polyurethane polymer. The corresponding polyurethane polymer coating fowled with the UV light absorber has a refractive index ranging from about 1.53 to about 1.63 and an aromatic functional group content ranging from about 16% to about 42% by weight of the solids of the polyurethane polymer.

The selection of suitable organic solvents used with the prepolymer reaction is dependent upon the selection of constituent components reacted to form the polyurethane polymer, including those solvents able to solve the selected active hydrogen compounds and those solvents that do not readily react with the polyisocyanates. Examples of suitable organic solvents useful for reacting the polyurethane prepolymer include ketones such as methylethylketone, acetone, methylisobutylketone, diacetone alcohol, and pentanedione; dioxane; N-methyl pyrrolidone; acetonitrile; esters; glycol esters; and tertiary alcohols such as tertiary amyl alcohol.

Depending upon the diisocyanates or active hydrogen compounds used to form the polyurethane polymer, catalysts can be added to the solution used to prepare the polyurethane prepolymer. Suitable catalysts useful for the preparation of the polyurethane prepolymer include metal carboxylates (i.e., metal salts of carboxylic acids), such as tin(II) ethylhexanoate, dibutyltindilaurate, and dibutylin bis(octylmaleate).

In the second basic step of preparing an aqueous polyurethane dispersion, the resulting polyurethane prepolymer or polymer is dispersed in an aqueous solution. The polyurethane prepolymer or polymer is dispersed in the presence of water with the aid of a dispersing agent, or alternatively, the polyurethane prepolymer or polymer is dispersed with the aid of a dispersing agent and mixing. The dispersing agent gives the polyurethane polymer miscible or solvable subsets that act to aid or enhance the dispersibility of the polymer as a particle in the water phase. In accordance with the high refractive coating compositions described herein, a carboxylic acid is reacted in the presence of the diisocyanates during the formation of the prepolymer to incorporate a carboxylic acid functional group into the polyurethane polymer structure. Preferably, a dihydroxycarboxylic acid is used to covalently bond to the polyurethane prepolymer structure during the prepolymer reaction to incorporate the carboxylic acid functional group as a segment in the backbone of the polyurethane prepolymer, thereby creating a reactive site for dispersing agent in the polyurethane polymer. After the formation of this polyurethane prepolymer, the carboxylic functional group in the polyurethane backbone is neutralized by a dispersing agent, such as a tertiary amine, in the presence of a sufficient amount of water capable of dispersing the polyurethane prepolymer or polymer. The neutralization of the carboxylic acid functional group creates an anionically stable dispersion of the polyurethane prepolymer or polymer in water. If mixing is used, the neutralization with the dispersing agent takes place before, during, or after the introduction of the mixing to this high refractive index polyurethane coating composition. The mixing includes high shear stress or mixing caused with the aid of a device such as high shear disperser, a homogenizer, or other device capable of dispersing polyurethane particles.

Suitable dihydroxycarboxylic acids for the high refractive index polyurethane coating compositions described herein include any carboxylic acid having at least two hydroxyl functional groups. Dihydroxycarboxylic acids are represented by the general form of (HO)₂R⁴(COOH), wherein R⁴ is an unbranched or branched alkyl group having from about one to about 12 carbon atoms. Examples of dihydroxycarboxylic acids include, without limitation, dimethylolpropionic acid (DMPA), dimethylolbutanoic acid (DMBA), and other dihydroxy-derivatives of ethanoic acid, propanoic acid, butanoic acid, pentanoic acid, hexanoic, decanoic acid, dodecanoic acid, octadecanoic acid, and the like. A preferred dihydroxycarboxylic acid used in the aqueous polyurethane dispersion includes DMPA.

Examples of suitable dispersing agents used herein to neutralize the carboxylic acid functional group to aid in the dispersion of the polyurethane polymers include anionic bases such as tertiary amines, ammonium hydroxide, phosphines, and metal hydroxides, preferably tertiary amines. Examples of specific non-limiting tertiary amines include triethanolamine, dimethyl enthanolamine, trimethylamine, triethylamine, and the like.

As the final step in preparing the aqueous dispersion, a chain extender is used to extend the polyurethane prepolymer in the final polymerization stage to high molecular weight dispersed polyurethane polymer. This final step takes place before, during, or after the dispersion step, i.e., rather than dispersing the prepolymer, the high molecular weight chain extended polyurethane polymer is dispersed or the dispersion occurs concurrently with the chain extension. The isocyanate-terminated end groups in the prepolymer react in the presence of chain extenders, such as multi-functional amines, multi-functional polyols, urea, or combinations thereof, to extend the polyurethane prepolymers to higher molecular weight polyurethane polymers. Specific examples of suitable chain extenders useful in accordance with the coating compositions described herein include hydrazine monohydrate, aqueous hydrazine (30%), 1,6-hexanediamine, 1,2-ethylenediamine, 1,3-propanediamine, 1,4-buthanediamine, 1,5-pentanediamine, 1,8-diaminooctane, 2-(2-aminoethyl)aminoethanol, 3-aminomethyl-3,5,5-trimethylcyclohexylamine, diaminotoluene, m-xylylenediamine or combinations thereof. Upon final polymerization, the aqueous polyurethane polymer dispersion is cooled to a storage stable temperature, such as ambient temperature and is ready to be stored, further processed, i.e., diluted, or applied as a coating to a substrate, which upon curing, provides a transparent, impact-resistant, high refractive index primer coating.

After the chain extender is added, the aqueous polyurethane dispersion coating compositions are optionally further processed. For example, the residual organic solvent in the coating composition used in prepolymer reaction is optionally evaporated off by heating up, by reducing the pressure, or by combinations of heating up and reducing the pressure of the coating composition.

Depending on the viscosity, the high refractive index aqueous polyurethane dispersion coating compositions are further prepared as primer coating compositions by diluting the dispersion with at least one organic solvent prior to applying the composition to the substrate. Examples of suitable organic solvents used in this preparation of the coating composition include propylene glycol monomethyl ether (PGME), dipropylene glycol methyl ether (DPM), ethylene glycol n-butyl ether (EB), diethylene glycol n-butyl ether (DB), diethylene glycol methyl ether (DM), n-butanol, isopropanol, ethanol, and methanol. The amount of diluent added to the dispersions is ascertainable by one of ordinary skill in the art depending on the desired viscosity of the high refractive index primer coating composition. Dilution with a suitable solvent does not affect the storage stability of the aqueous polyurethane dispersion. Optionally, any other additives or diluents, such as surfactants, leveling or flow control agents, etc., are added to the dispersion prior to applying as a coating.

An effective amount of a leveling or flow control agent can be incorporated into the coating composition described herein to spread more evenly or level the composition on the surface of the substrate and to provide substantially uniform contact with the substrate. The amount of the leveling or flow control agent can vary widely, but can be an amount sufficient to provide the coating composition with from about 10 to about 5,000 ppm of the leveling or flow control agent. Any conventional, commercially available leveling or flow control agent which is compatible with the coating composition and the substrate, which is capable of leveling the coating composition on a substrate, and which enhances wetting between the coating composition and the substrate can be employed. Non-limiting examples of such flow-control agents include polyethers, silicones, or fluorosurfactants.

The aqueous polyurethane coating compositions described herein are applied in any suitable manner to a substrate. For example, the compositions of the invention can be applied to solid substrates by conventional methods, such as flow coating, spray coating, curtain coating, dip coating, spin coating, roll coating, and the like to form a continuous surface film on the substrate.

The aqueous polyurethane coating compositions are applied to the substrate and at least partially cured before the application of any additional coating compositions or layers, such as a hard coat or a top coat, over the polyurethane layer. The polyurethane coating compositions described herein cure by air drying at ambient temperature or higher. As used herein, ambient temperature refers to a range of temperatures from about 20° C. to about 28° C. Suitable curing temperatures range from ambient temperature to about 150° C. The curing time for the coating compositions to be sufficiently cured to allow another coating to be applied over it will vary depending on the coating thickness and curing environment, i.e., humidity, temperature, presence of convective currents, etc., but is less than one hour at ambient temperature, preferably less than 35 minutes. Heat or irradiation can additionally be used to decrease the amount of time it takes to cure, but neither heat nor irradiation are required to initiate or sustain the curing of the polyurethane coating compositions described herein. The polyurethane layer can take up to several weeks at ambient temperature to fully cure, and consequently, obtain the properties of the fully cured polyurethane layer.

The aqueous polyurethane dispersion coating compositions described herein form thermoset, i.e., crosslinked, polyurethane coatings upon curing. The thermoset property of the polyurethane coating prevents additional coatings or layers applied over it from adversely attacking or dissolving the polyurethane layer. Accordingly, additional coating compositions or layers can be applied to the polyurethane layer as long as the polyurethane layer has been allowed to sufficiently cure, i.e., the partial curing of the thermoset polyurethane layer is sufficient to prevent the additional coating compositions or layers from being able to attack or dissolve the polyurethane layer. Moreover, if the polyurethane layer is not fully or completely cured when an additional coating composition or layer is applied, i.e., the polyurethane layer is only sufficiently cured to prevent the additional layer from attacking or dissolving the polyurethane layer, then the polyurethane layer will continue curing at ambient temperature after the additional coating composition or layer is applied until the polyurethane layer is fully cured. Alternatively or in addition, curing the additional coating composition or layer by heat or irradiation will also fully cure the underlying polyurethane layer.

The aqueous polyurethane dispersion coating compositions described herein can be applied as a coating to rigid substrate surfaces or substrate surfaces that are sufficiently flexible to withstand further processing of the substrate, such as molding or shaping, without loss of its properties. A variety of substrates are employed. Among the preferred substrate materials include transparent substrates or transparent plastics such as polycarbonate, acrylic, polyurethane, polythiourethane, polyvinylchloride, polybisallyl carbonate, polyethylene terephthalate, and polyethylene naphthenate. Other substrates include various polyolefins, fluorinated polymers, metals and glass, such as soda-lime glass, borosilicate glass, and acrylic glass, among other types of glass, may also be used with appropriate pretreatments.

Depending on the substrate used, the substrate can be pretreated to enhance the adhesion of the polyurethane coating composition to the substrate. Suitable pretreatments include dry pretreatments, such corona or plasma treatment, or chemical treatments such as chemical etching. Examples of suitable solutions used in chemical etching include 5% to 20% by weight aqueous sodium hydroxide solution or 5% to 20% by weight aqueous potassium hydroxide solution. The chemical etching process includes dipping the substrate in a bath of the etching solution, rinsing with deionized water, and air drying. An ultrasonic bath of chemical etching solution can be used. Preferably, chemical etching occurs at temperatures ranging from about 40° C. to about 60° C.

Substrates coated with the aqueous polyurethane coating compositions described herein can be overcoated with any suitable hard coat or top coat. The hard coat or top coat adheres to the polyurethane coating formed from the aqueous polyurethane dispersion coating compositions. The hard coat or top coat is used to form a layer over the polyurethane coated substrate to protect the substrate from scratching or marring. Examples of suitable hard coats include coatings that are formed from organosiloxane coating compositions.

In accordance with other embodiments of the present invention, articles are provided. The articles comprise a substrate having a coating on at least one surface in accordance with the high refractive index aqueous polyurethane dispersion coating compositions described herein.

An article comprising a high refractive index, transparent substrate coated with a coating composition, which when applied to the substrate and cured, provides a transparent, impact-resistant, high refractive index primer coating is provided herein. The coating composition of the article comprises a polyurethane polymer having aromatic functional groups in an amount ranging from about 16% to about 42% by weight of the solids of the polyurethane polymer, wherein the polyurethane polymer comprises reaction products of an aromatic diisocyanate; at least one active hydrogen compound selected from the group consisting of: i) an aliphatic diol having from about 2 to about 8 carbons, ii) an aromatic diol, iii) a sulfide functional alkyl compound having from about 2 to about 4 carbons, iv) a thiol functional hydrocarbon compound having from about 2 to about 8 carbons, and v) combinations thereof; a dihydroxycarboxylic acid; and a multi-functional amine. The coating composition includes a dispersing agent and an amount of water sufficient to disperse the polyurethane polymer to form an aqueous polyurethane dispersion coating composition. The article further comprises a polyurethane polymer formed from reaction products of the aromatic diisocyanate, the at least one active hydrogen compound, the dihydroxycarboxylic acid, the multi-functional amine, and a polymer diol. Additionally, the article further includes the aqueous polyurethane dispersion coating composition comprising an ultraviolet light absorber. The primer coating formed from the coating composition has a refractive index ranging from about 1.53 to about 1.63.

In accordance with another embodiment, processes for preparing the aqueous polyurethane dispersion coating compositions are provided. A process for preparing a coating composition, which when applied to a substrate and cured, provides a transparent, impact-resistant, high refractive index primer coating, the process comprising reacting an aromatic diisocyanate, at least one active hydrogen compound, and a dihydroxycarboxylic acid in an organic solvent to form a polyurethane prepolymer, wherein the at least one active hydrogen compound is selected from the group consisting of i) an aliphatic diol having from about 2 to about 8 carbons, ii) an aromatic diol, iii) a sulfide functional alkyl compound having from about 2 to about 4 carbons, iv) a thiol functional hydrocarbon compound having from about 2 to about 8 carbons, and v) combinations thereof The process includes dispersing the polyurethane prepolymer into water by neutralizing the carboxylic functional group of the prepolymer attributed to the dihydroxycarboxylic acid with a dispersing agent. Moreover, the process comprises adding a multi-functional amine to chain extend the polyurethane prepolymer to a high molecular weight polyurethane polymer. The polyurethane polymer comprises aromatic functional groups in an amount ranging from about 16% to about 42% by weight of the solids of the polyurethane polymer. The process further comprises reacting a polymer diol with the aromatic diisocyanates, the at least one active hydrogen compound, and the dihydroxycarboxylic acid, and the multi-functional amine to form the polyurethane prepolymer. Alternatively or in addition, the process further comprises adding an ultraviolet light absorber to the prepolymer prior to dispersing the polyurethane prepolymer into water. When cured, the aqueous polyurethane coating composition forms a primer coating having a refractive index ranging from about 1.53 to about 1.63.

In accordance with another embodiment, processes for coating a transparent substrate having a high refractive index are provided. As discussed above, substrates that are susceptible to damage from impact, particularly hard-coated, transparent plastic substrates, are coated with the aqueous polyurethane coating compositions described herein to improve the impact resistance and adhesive qualities of a hard-coated, high refractive index transparent substrate. The processes improve the impact resistance of the hard-coated high refractive index, transparent substrates by coating the substrate with the high refractive index polyurethane coating composition to foam an elastomeric, adhesive polyurethane primer layer between the hard coat and the substrate.

Accordingly, a process for coating a transparent, substrate having a high refractive index comprises applying an aqueous polyurethane dispersion coating composition to at least one surface of the substrate, wherein the aqueous polyurethane dispersion coating composition comprises a polyurethane polymer having aromatic functional groups in an amount ranging from about 16% to about 42% by weight of the solids of the polyurethane polymer, a dispersing agent, and an amount of water sufficient to disperse the polyurethane polymer to form an aqueous polyurethane dispersion coating composition. The polyurethane polymer comprises the reaction products of an aromatic diisocyanate; at least one active hydrogen compound selected from the group consisting of i) an aliphatic diol having from about 2 to about 8 carbons, ii) an aromatic diol, iii) a sulfide functional alkyl compound having from about 2 to about 4 carbons, iv) a thiol functional hydrocarbon compound having from about 2 to about 8 carbons, and v) combinations thereof; a dihydroxycarboxylic acid; and a multi-functional amine. The process includes at least partially curing the aqueous polyurethane dispersion coating composition on the at least one surface of the substrate to faun a polyurethane polymer primer coating, wherein the polyurethane polymer primer coating has a refractive index ranging from about 1.53 to about 1.63. The process further includes applying a hard coat coating composition to the polyurethane polymer primer coating and curing the hard coat coating composition to form a transparent, impact-resistant, high refractive index substrate having a hard coating. Additionally, a suitable hard coat coating composition used in accordance with this embodiment includes an organosiloxane coating composition.

Another process for coating a transparent substrate having a high refractive index to improve the impact resistance and adhesive properties of the substrate is provided. The process comprises selecting a hard coat coating composition, which when cured, forms a hard coating and selecting an aqueous polyurethane dispersion coating composition, which when cured forms a polyurethane polymer coating having a refractive index ranging from about 1.53 to about 1.63. The aqueous polyurethane dispersion coating composition comprises a polyurethane polymer having aromatic functional groups in an amount ranging from about 16% to about 42% by weight solids of the polyurethane polymer, a dispersing agent, and an amount of water sufficient to disperse the polyurethane polymer to form an aqueous polyurethane dispersion coating composition. The polyurethane polymer comprises reaction products of an aromatic diisocyanate; at least one active hydrogen compound selected from the group consisting of: i) an aliphatic diol having from about 2 to about 8 carbons, ii) an aromatic diol, iii) a sulfide functional alkyl compound having from about 2 to about 4 carbons, iv) a thiol functional hydrocarbon compound having from about 2 to about 8 carbons, and v) combinations thereof; a dihydroxycarboxylic acid; and a multi-functional amine. After selecting the coating compositions, the process includes applying the aqueous polyurethane dispersion coating composition to at least one surface of the substrate and at least partially curing the aqueous polyurethane dispersion coating composition on the substrate to form a polyurethane polymer coating. The hard coat is then applied to the substrate by applying the hard coat coating composition to the polyurethane polymer coating and curing the hard coat coating composition to form a transparent, impact-resistant, high refractive index hard-coated substrate.

In accordance with the processes for coating a high refractive index, transparent substrate, the polyurethane polymer further comprises the reaction products of the aromatic diisocyanate, the at least one active hydrogen compound, the dihydroxycarboxylic acid, the multi-functional amine, and a polymer diol. Moreover, in accordance with this embodiment, the processes further include at least partially curing the aqueous polyurethane coating composition at ambient temperature by air-drying. Alternatively or in addition, the aqueous polyurethane dispersion coating compositions used in accordance with this embodiment comprise an ultraviolet light absorber.

The elements of the process described herein are not intended to be limited to any specific order, when not in contravention to the embodiments described herein.

The following analytical test methods and examples are for purposes of illustration only and are not intended to limit the scope of the invention as defined in the claims which are appended hereto.

### ANALYTICAL TEST METHODS

Parameters and values used to quantify certain elements of the present invention, including but not limited to the examples presented herein, are described in detail as follows:

Substrate Used:

Unless otherwise indicated in the Examples below, acrylic or polythiourethane ophthalmalic lenses are used as the substrates. Multiple lenses are coated with each sample of the Examples. Different lenses with the same coating are used in the different types of tests, i.e., a different lens with the same coating is used for each of the adhesion test and impact test. Before applying coatings to the lenses as described in the Examples below, the lenses were etched by dipping lenses into an aqueous 10% by weight NaOH solution at 60° C. for 10 minutes. The etched lenses were rinsed by deionized water and then dried at ambient temperature.

Application of Aqueous Polyurethane Dispersion Primer Coating to the Substrate:

The lenses are dip-coated in the aqueous polyurethane dispersion coating composition having a 4 inch/min draw speed. The dip-coated lens is cured for 15 minutes at 80° C.

Application of the Hard Coat to the Substrate:

The lenses are dip-coated in the hard coat coating composition having a 6 inch/min draw speed. The dip-coated lens is then cured for 3 hours at 110° C.

Coating Thickness Measurement:

The measurement of the coating thickness for each layer of coating, i.e., the primer coating and the hard coat, is made using an F-20 Film Measurement Unit with a contact stage, available from Filmetrics, Inc. of San Diego, Calif.

Refractive Index Measurements:

The refractive index measurements for each coating are taken on a Metricon 2010/M prism coupler at 594 nanometers (nm), available from Metricon Corporation of Pennington, N.J.

Adhesion Test

The coated lens is soaked in boiling water for 1 hour. After cooling and drying, a cross-hatched pattern is made on the coating of the lens with a razor blade. Tape is then applied to the cross-hatched section of the coated lens. After the tape is applied, the tape is removed from the coating. The application and removal of the tape is repeated three times. If none of the coating is removed from the lens during the repeated application and removal of the tape, then the coating composition passes the test at 100%. If any of the coating is removed from the lens due to the repeated application and removal of the tape, then the coating composition fails the test. The tape used in accordance with the adhesion test is Scotch ® brand tape, Scotch 600 from 3M Company of St. Paul, Minn.

Percent Haze:

The percent haze of the coated lens is measured using a Haze-Gard Plus available from BYK Gardner USA of Columbia, Md.

Impact Test:

A 16 gram (g) steel ball is dropped on the coated lens from a height of 50 inches, using a Square Shooter II Dual Drop Ball Tester, available from Brain Power, Inc. of Miami, Fla.

Interference Pattern:

The coated lens is observed through a double slit under a green light provided by a UniLamp UL-12 model lamp available from Midwest Scientific Co. of Valley Park, Mo., and the observations are reported herein. The observations are reported as follows: no interference pattern is considered an excellent result, a slight interference pattern is considered a good result, and a heavy interference pattern is considered a bad result.

List of Materials and Abbreviations Used in the Following Examples:

BPX-11: Bisphenol A propoxylate, available from ADEKA Corporation of Japan.

Coatosil 1211: A flow control (wetting) agent coating additive, available from Momentive Performance Materials of Albany, N.Y.

IM-1186 JJ-C-60: IM-1186 JJ-C-60 hard coating with a refractive index of 1.54, available from SDC Technologies, Inc of Irvine, Calif.

IM-9000: A hard coating with a refractive index of 1.60, available from SDC Technologies, Inc.

PR-1135: A primer coating with a refractive index of 1.50, available from SDC Technologies, Inc.

UVA: Tinuvin® 234 UV light absorber, available from BASF SE of Germany.

XDI: m-xylylene diisocyanate from Mitsui Chemicals, Inc. of Japan.

### EXAMPLES

### Example 1

### Preparation of High Refractive Index Aqueous Polyurethane Dispersion With a Polymer Diol and a Short-Chain Aliphatic Diol

Mix 21.6 g of XDI, 16.4 g of poly(hexamethylene carbonate) diol (M_{w} 2000), 5.4 g of 1,6-hexanediol, 3.8 g of dimethylolpropionic acid, and 50 g of acetonitrile. Heat the mixture up to 70° C., and react for 2 hours. Cool the mixture down to 60° C., and add 2.8 g of triethylamine to neutralize carboxylic group from dimethylolpropionic acid. An aqueous dispersion of polyurethane with a solid content of 20% by weight was prepared by dispersing 37.6 g of polyurethane solution above into 61.2 g of water with high shear disperser, further mixing in 1.2 g of 2-[(2-aminoethyl)amino]ethanol. The cured polyurethane coating from the resulting polyurethane dispersion had a refractive index of 1.532. The aromatic functional groups comprise about 16% by weight of the solids of the polyurethane polymer.

### Example 2

### Preparation of High Refractive Index Aqueous Polyurethane Dispersion With a Short-Chain Aliphatic Diol

Mix 36.4 g of XDI, 6.8 g of ethylene glycol, 3.9 g of dimethylolpropionic acid, and 50 g of methylethylketone. Heat the mixture up to 70° C., and react for 2 hours. Cool the mixture down to 50° C., and add 2.9 g of triethylamine to neutralize carboxylic group from dimethylolpropionic acid. An aqueous dispersion of polyurethane with a solid content of 20% weight was prepared by dispersing 36.2 g of polyurethane solution above into 61.9 g of water with high shear disperser, further mixing in 1.9 g of 2-[(2-aminoethyl)amino]ethanol. The cured polyurethane coating from the resulting polyurethane dispersion had a refractive index of 1.572. The aromatic functional groups comprise about 27% by weight of the solids of the polyurethane polymer.

### Example 3

### Preparation of High Refractive Index Aqueous Polyurethane Dispersion With a Short-Chain Aliphatic Diol and an Aromatic Diol

Mix 29.0 g of XDI, 3.1 g of ethylene glycol, 12.0 g of BPX-11, 3.4 g of dimethylolpropionic acid, and 50 g of methylethylketone. Heat the mixture up to 70° C. and react for 2 hours. Cool the mixture down to 50° C., and add 2.5 g of triethylamine to neutralize carboxylic group from dimethylolpropionic acid. An aqueous dispersion of polyurethane with a solid content of 25% weight was prepared by dispersing 45 g of polyurethane solution above into 75 g of water with high shear disperser, further mixing in 2.5 g of 2-[(2-aminoethyl)amino]ethanol, and evaporating methylethylketone from the dispersion. The cured polyurethane coating from the resulting polyurethane dispersion had a refractive index of 1.572. The aromatic functional groups comprise about 26% by weight of the solids of the polyurethane polymer.

### Example 4

### Preparation of High Refractive Index Aqueous Polyurethane Dispersion With a Thiol Functional Hydrocarbon Compound

Mix 35.3 g of XDI, 5.8 g of 2-mercaptoethanol, 0.6 g of trimethylolpropane, 4.2 g of dimethylolpropionic acid, and 50 g of 1,4-dioxane. Heat the mixture up to 70° C., and react for 2 hours. Cool the mixture down to 50° C., and add 3.1 g of triethylamine to neutralize carboxylic group from dimethylol propionic acid. An aqueous dispersion of polyurethane with a solid content of about 20% weight was prepared by dispersing 35.7 g of polyurethane solution above into 62.1 g of water with high shear disperser, further mixing in 2.1 g of 2-[(2-aminoethyl)amino]ethanol. The cured polyurethane coating from the resulting polyurethane dispersion had a refractive index of 1.593. The aromatic functional groups comprise about 26% by weight of the solids of the polyurethane, and the sulfur comprises about 0.6% by weight solids of the polyurethane polymer.

### Example 5

### Preparation of High Refractive Index Aqueous Polyurethane Dispersion With a Short-Chain Aliphatic Diol and an UV Absorber

Mix 34.4 g of XDI, 6.4 g of ethylene glycol, 3.7 g of dimethylolpropionic acid, and 50 g of methylethylketone. Heat the mixture up to 70° C., and react for 2 hours. Cool the mixture down to 50° C., and add 2.7 g of triethylamine to neutralize carboxylic group from dimethylolpropionic acid. Add 2.8 g of UVA into the prepolymer solution. An aqueous dispersion of polyurethane with a solid content of 25% weight was prepared by dispersing 45 g of polyurethane solution above into 75 g of water with high shear disperser, further mixing in 2.5 g of 2-[(2-aminoethyl)amino]ethanol, and evaporating methylethylketone from the dispersion. The cured polyurethane coating from the resulting polyurethane dispersion had a refractive index of 1.575. The aromatic functional groups comprise about 26% by weight of the solids of the polyurethane polymer, and the ultraviolet light absorber comprises about 5.8% by weight solids of the polyurethane polymer.

### Example 6

### Preparation of High Refractive Index Aqueous Polyurethane Dispersion With a Polymer Diol and a Short-Chain Aliphatic Diol

Mix 28.5 g of XDI, 10.6 g of poly(hexamethylene carbonate) diol (M_{w} 860), 4.5 g of ethylene glycol, 3.9 g of dimethylolpropionic acid, and 50 g of methylethylketone. Heat the mixture up to 70° C., and react for 2 hours. Cool the mixture down to 65° C., and add 2.9 g of triethylamine to neutralize carboxylic group from dimethylolpropionic acid. An aqueous dispersion of polyurethane with a solid content of 20% by weight was prepared by dispersing 37.0 g of polyurethane solution above into 61.5 g of water with high shear disperser, further mixing in 1.5 g of 2-[(2-aminoethyl)amino]ethanol. The cured polyurethane coating from the resulting polyurethane dispersion had a refractive index of 1.552. The aromatic functional groups comprise about 21% by weight of the solids of the polyurethane polymer.

### Example 7

### Preparation of a Lens Having the High Refractive Index Primer Coating Composition of Example 1

Mix 40 g of aqueous polyurethane dispersion from Example 1 with 60 g of propylene glycol monomethyl ether, and then add 0.1 g of Coatosil 1211. This primer coating composition having a refractive index of 1.532, when cured, was applied to an acrylic lens substrate, air-dried for 10 minutes at 80° C., and over-coated with the IM 1186 JJ-C-60 hard coat commercially available from SDC Technologies, Inc. The coated lens of Example 7 passed each of the adhesion test and impact test. This coated lens exhibited good interference pattern results with a slight interference pattern observed through the coated lens. The test results and the specific properties of this lens are reported in Table 1 below. In addition, the coated lens of Example 7 was also compared in Table 1 to Examples 8-10 below.

### Example 8

### Preparation of a Lens Having the High Refractive Index Primer Coating Composition of Example 6

Mix 40 g of aqueous polyurethane dispersion from Example 6 with 60 g of propylene glycol monomethyl ether, and then add 0.1 g of Coatosil 1211. This primer coating composition having a refractive index of 1.552, when cured, was applied to an acrylic lens substrate, air-dried for 30 minutes at ambient temperature (the coating was tack-free after 20 minutes of air-drying), and over-coated with the IM 1186 JJ-C-60 hard coat commercially available from SDC Technologies, Inc. The coated lens of Example 8 passed each of the adhesion test and impact test. This coated lens exhibited good interference pattern results with a slight interference pattern observed through the coated lens. The test results and the specific properties of this lens are reported in Table 1 below. In addition, the coated lens of Example 8 was also compared in Table 1 to Examples 7 and 9-10 below.

### Example 9

### Preparation of a Lens Having a Primer Coating Composition With a Refractive Index of 1.50

A PR-1135 primer coating composition with a refractive index of 1.50, when cured, commercially available from SDC Technologies, Inc., was applied to an acrylic lens substrate, air-dried for 30 minutes at ambient temperature, and over-coated with the IM 1186 JJ-C-60 hard coat. This coated lens of Example 9 passed each of the adhesion test and impact test. This coated lens exhibited poor interference pattern results because a heavy interference pattern was observed through the coated lens. The test results and the specific properties of this coated lens are reported in Table 1 below, in addition to the test results and properties of Examples 7, 8 and 10.

### Example 10

### Preparation of a Lens With No Primer Coating

The IM 1186 JJ-C-60 hard coat was applied directly to an acrylic lens substrate without a primer coating. This coated lens of Example 10 passed the adhesion test but failed the impact test. This coated lens exhibited excellent interference pattern results because no interference pattern was observed through the coated lens. The test results and the specific properties of this coated lens are reported in Table 1 below, in addition to the test results and properties of Examples 7, 8, and 9.

TABLE 1
Examples 7-10 Properties and Test Results

| | Primer Coating | | | | |
|---|---|---|---|---|---|
| | | | | Example 9 | Example 10 |
| | Coating | Example 7 | Example 8 | (PR-1135) | (No Primer) |
| | Refractive | 1.53 | 1.55 | 1.50 | — |
| | index | | | | |
| | Thickness (μm) | 1.4 | 1.7 | 1.5 | — |
| Substrate | Type | Acrylic | Acrylic | Acrylic | Acrylic |
| | | resin | resin | resin | resin |
| | Refractive | 1.55 | 1.55 | 1.55 | 1.55 |
| | index | | | | |
| | Center | 1.2 | 1.2 | 1.2 | 1.2 |
| | thickness (mm) | | | | |
| | Hard Coating | | | | |
| | | IM-1186 | IM-1186 | IM-1186 | IM-1186 |
| | Coating | JJ-C-60 | JJ-C-60 | JJ-C-60 | JJ-C-60 |
| | Refractive | 1.54 | 1.54 | 1.54 | 1.54 |
| | index | | | | |
| | Thickness (μm) | 2.5 | 2.5 | 2.5 | 2.5 |
| Properties | Adhesion test | 100% | 100% | 100% | 100% |
| | Impact test | Pass—No | Pass—No | Pass—No | Failed—Cracked |
| | | cracking | cracking | cracking | |
| | Interference | Good—Slight | Good—Slight | Bad—Heavy | Excellent—No |
| | pattern | Pattern | Pattern | Pattern | Pattern |

### Example 11

### Preparation of a Lens Having the High Refractive Index Primer Coating Composition of Example 2

Mix 40 g of aqueous polyurethane dispersion from Example 2 with 40 g of propylene glycol monomethyl ether and 20 g of methanol, and then add 0.1 g of Coatosil 1211. This primer coating composition having a refractive index of 1.572, when cured, was applied to polythiourethane lens substrate, air-dried for 10 minutes at 80° C., and over-coated with the IM-9000 hard coat, commercially available from SDC Technologies, Inc. This coated lens of Example 11 passed each of the adhesion test and impact test. This coated lens exhibited good interference pattern results with a slight interference pattern observed through the coated lens. The test results and the specific properties of this coated lens are reported in Table 2 below. In addition, the coated lens of Example 11 was also compared in Table 2 to Examples 12-14 below.

### Example 12

### Preparation of a Lens Having the High Refractive Index Primer Coating Composition of Example 4

Mix 40 g of aqueous polyurethane dispersion from Example 4 with 40 g of propylene glycol monomethyl ether and 20 g of methanol, and then add 0.1 g of Coatosil 1211. This primer coating composition having a refractive index of 1.593, when cured, was applied to a polythiourethane lens substrate, air-dried for 10 minutes at 80° C., and over-coated with the IM-9000 hard coat. This coated lens of Example 12 passed each of the adhesion test and impact test. This coated lens exhibited good interference pattern results with a slight interference pattern observed through the coated lens. The test results and the specific properties of this coated lens are reported in Table 2 below. In addition, the coated lens of Example 12 was also compared in Table 2 to Examples 11 and 13-14.

### Example 13

### Preparation of a Lens Having a Primer Coating Composition With a Refractive Index of 1.50

A PR-1135 primer coating composition with a refractive index of 1.50, when cured, was applied to a polythiourethane lens substrate, air-dried for 30 minutes at ambient temperature, and over-coated with the IM-9000 hard coat. This coated lens of Example 13 passed each of the adhesion test and impact test. This coated lens exhibited poor interference pattern results because a heavy interference pattern was observed through the coated lens. The test results and the specific properties of this coated lens are reported in Table 1 below, in addition to the test results and properties of Examples 11-12 and 14.

### Example 14

### Preparation of a Lens With No Primer Coating

The IM-9000 hard coat was applied directly to a polythiourethane lens substrate without a primer coating. This coated lens of Example 14 passed the adhesion test but failed the impact test. This coated lens exhibited excellent interference pattern results because no interference pattern was observed through the coated lens. The test results and the specific properties of this coated lens are reported in Table 2 below, in addition to the test results and properties of Examples 11-13.

TABLE 2
Example 11-14 Properties and Test Results

| | Primer Coating | | | | |
|---|---|---|---|---|---|
| | | | | Example 13 | Example 14 |
| | Coating | Example 11 | Example 12 | (PR-1135) | (No Primer) |
| | Refractive | 1.57 | 1.59 | 1.50 | — |
| | index | | | | |
| | Thickness (μm) | 1.3 | 1.0 | 1.5 | — |
| Substrate | Type | PTH* | PTH* | PTH* | PTH* |
| | Refractive | 1.60 | 1.60 | 1.60 | 1.60 |
| | index | | | | |
| | Center | 1.2 | 1.2 | 1.2 | 1.2 |
| | thickness (mm) | | | | |
| | Hard Coating | | | | |
| | Coating | IM-9000 | IM-9000 | IM-9000 | IM-9000 |
| | Refractive | 1.60 | 1.60 | 1.60 | 1.60 |
| | index | | | | |
| | Thickness (μm) | 3.0 | 3.0 | 3.0 | 3.0 |
| Properties | Adhesion test | 100% | 100% | 100% | 100% |
| | Impact test | Pass—No | Pass—No | Pass—No | Failed—Cracked |
| | | cracking | cracking | cracking | |
| | Interference | Good—Slight | Good—Slight | Bad—Heavy | Good—Slight |
| | pattern | Pattern | Pattern | Pattern | Pattern |

PTH* = Polythiourethane resin, i.e., MR-8 ™ resin available from Mitsui Chemicals, Inc. of Japan.

### Comparative Example 1

### Preparation of an Aqueous Polyurethane Dispersion With a Polymer Diol

Mix 12.1 g of)(DI, 30.7 g of poly(hexamethylene carbonate) diol (M_{w} 2000), 4.1 g of dimethylolpropionic acid, and 50 g of acetonitrile. Heat the mixture up to 70° C., and react for 2 hours. Cool the mixture down to 60° C., and add 3.0 g of triethylamine to neutralize carboxylic group from the dimethylolpropionic acid. An aqueous dispersion of polyurethane with a solid content of about 20% weight was prepared by dispersing 37.6 g of polyurethane solution above into 61.2 g of water with high shear disperser, further mixing in 1.2 g of 2-[(2-aminoethyl)amino]ethanol. The cured polyurethane coating from the resulting polyurethane dispersion had a refractive index of 1.505. The aromatic functional groups comprise about 9% by weight of the solids of the polyurethane polymer.

### Comparative Example 2

### Preparation of an Aqueous Polyurethane Dispersion With a Polymer Diol and a Short-Chain Aliphatic Diol

Mix 16.9 g of XDI, 30.7 g of poly(hexamethylene carbonate) diol (M_{w} 2000), 2.8 g of 1,6-hexanediol, 3.8 g of dimethylolpropionic acid, and 50 g of methylethlketone. Heat the mixture up to 70° C., and react for 2 hours. Cool the mixture down to 60° C., and add 2.8 g of triethylamine to neutralize carboxylic group from dimethylolpropionic acid. An aqueous dispersion of polyurethane with a solid content of about 20% weight was prepared by dispersing 38.1 g of polyurethane solution above into 60.9 g of water with high shear disperser, further mixing in 1.2 g of 2-[(2-aminoethyl)amino]ethanol. The cured polyurethane coating from the resulting polyurethane dispersion had a refractive index of 1.519. The aromatic functional groups comprise about 13% by weight of the solids of the polyurethane polymer.

It will be understood that various changes may be made without departing from the scope of the invention, which is not to be considered limited to what is described in the description.

What is claimed is:

1. A coating composition which, when applied to a substrate and cured, provides a transparent, impact-resistant, high refractive index primer coating, comprising:
a polyurethane polymer having aromatic functional groups in an amount ranging from about 16% to about 42% by weight of the solids of the polyurethane polymer, wherein the polyurethane polymer comprises the reaction products of:
an aromatic diisocyanate;
at least one active hydrogen compound selected from the group consisting of:
i) an aliphatic diol having from about 2 to about 8 carbons, ii) an aromatic diol, iii) a sulfide functional alkyl compound having from about 2 to about 4 carbons, iv) a thiol functional hydrocarbon compound having from about 2 to about 8 carbons, and v) combinations thereof;
a dihydroxycarboxylic acid; and
a multi-functional amine.

2. The composition of claim 1, further comprising a dispersing agent and an amount of water sufficient to disperse the polyurethane polymer to form an aqueous polyurethane dispersion coating composition.

3. The composition of claim 2, wherein the at least one active hydrogen compound is selected from the group consisting of the aliphatic diol having from about 2 to about 8 carbons, the aromatic diol, and combinations thereof.

4. The composition of claim 3, wherein the polyurethane polymer comprises aromatic functional groups in an amount ranging from about 16% to about 27% by weight of the solids of the polyurethane polymer, and wherein the primer coating has a refractive index ranging from about 1.53 to about 1.57.

5. The composition of claim 2, wherein the at least one active hydrogen compound is selected from the group consisting of the sulfide functional alkyl compound having from about 2 to about 4 carbons, the thiol functional hydrocarbon compound having from about 2 to about 8 carbons, and combinations thereof.

6. The composition of claim 5, wherein the polyurethane polymer comprises sulfur in an amount ranging from about 0.1% to about 15% by weight of the solids of the polyurethane polymer, and wherein the primer coating has a refractive index ranging from about 1.53 to about 1.63.

7. The composition of claim 2, wherein the aromatic diisocyanate is selected from a group consisting of a xylylene diisocyanate, a tetramethylxylene diisocyanate, and combinations thereof.

8. The composition of claim 1, wherein the reaction products further include a polymer diol, wherein the polyurethane polymer comprises aromatic functional groups in an amount ranging from about 16% to about 27% by weight of the solids of the polyurethane polymer, and the primer coating has a refractive index ranging from about 1.53 to about 1.57.

9. The composition of claim 8, further comprising a dispersing agent and an amount of water sufficient to disperse the polyurethane polymer to form an aqueous polyurethane dispersion coating composition.

10. An article comprising a high refractive index, transparent substrate coated with a coating composition, which when applied to the substrate and cured, provides a transparent, impact-resistant, high refractive index primer coating, the coating composition comprising:
a) a polyurethane polymer having aromatic functional groups in an amount ranging from about 16% to about 42% by weight of the solids of the polyurethane polymer, wherein the polyurethane polymer comprises reaction products of:
1) an aromatic diisocyanate,
2) at least one active hydrogen compound selected from the group consisting of: i) an aliphatic diol having from about 2 to about 8 carbons, ii) an aromatic diol, iii) a sulfide functional alkyl compound having from about 2 to about 4 carbons, iv) a thiol functional hydrocarbon compound having from about 2 to about 8 carbons, and v) combinations thereof,
3) a dihydroxycarboxylic acid, and
4) a multi-functional amine,
b) a dispersing agent; and
c) an amount of water sufficient to disperse the polyurethane polymer to form an aqueous polyurethane dispersion coating composition,
wherein the primer coating has a refractive index ranging from about 1.53 to about 1.63.

11. The article of claim 10, wherein the transparent substrate comprises at least one of a polycarbonate material, a polyurethane material, an acrylic material, a polythiourethane material, a polyvinylchloride material, a polybisallyl carbonate material, a polyethylene terephthalate material, and a polyethylene naphthenate material.

12. A process for coating a transparent, substrate having a high refractive index, the process comprising:
applying an aqueous polyurethane dispersion coating composition to at least one surface of the substrate, wherein the aqueous polyurethane dispersion coating composition comprises:
a) a polyurethane polymer having aromatic functional groups in an amount ranging from about 16% to about 42% by weight of the solids of the polyurethane polymer, wherein the polyurethane polymer comprises reaction products of:
1) an aromatic diisocyanate,
2) at least one active hydrogen compound selected from the group consisting of: i) an aliphatic diol having from about 2 to about 8 carbons, ii) an aromatic diol, iii) a sulfide functional alkyl compound having from about 2 to about 4 carbons, iv) a thiol functional hydrocarbon compound having from about 2 to about 8 carbons, and v) combinations thereof,
3) a dihydroxycarboxylic acid, and
4) a multi-functional amine;
b) a dispersing agent; and
c) an amount of water sufficient to disperse the polyurethane polymer to form an aqueous polyurethane dispersion coating composition; and
at least partially curing the aqueous polyurethane dispersion coating composition on the at least one surface of the substrate to form a polyurethane polymer primer coating, wherein the polyurethane polymer primer coating has a refractive index ranging from about 1.53 to about 1.63.

13. The process of claim 12, further comprising:
applying a hard coat coating composition to the polyurethane polymer primer coating; and
curing the hard coat coating composition to form a transparent, impact-resistant, high refractive index substrate having a hard coating.

14. The process of claim 13, wherein the hard coat coating composition comprises an organosiloxane coating composition.

15. The process of claim 12, wherein the at least one active hydrogen compound is selected from the group consisting of the aliphatic diol having from about 2 to about 8 carbons, the aromatic diol, and combinations thereof.

16. The process of claim 15, wherein the polyurethane polymer comprises aromatic functional groups in an amount ranging from about 16% to about 27% by weight of the solids of the polyurethane polymer, and wherein the polyurethane polymer primer coating has a refractive index ranging from about 1.53 to about 1.57.

17. The process of claim 12, wherein the at least one active hydrogen compound is selected from the group consisting of the sulfide functional alkyl compound having from about 2 to about 4 carbons, the thiol functional hydrocarbon compound having from about 2 to about 8 carbons, and combinations thereof.

18. The process of claim 17, wherein the polyurethane polymer comprises sulfur in an amount ranging from about 0.1% to about 15% by weight of the solids of the polyurethane polymer.

19. The process of claim 12, wherein the aromatic diisocyanate is selected from a group consisting of a xylylene diisocyanate, a tetramethylxylene diisocyanate, and combinations thereof.

20. The process of claim 12, wherein the reaction products further include a polymer diol, and wherein the polyurethane polymer comprises aromatic functional groups in an amount ranging from about 16% to about 27% by weight of the solids of the polyurethane polymer, and the polyurethane polymer primer coating has a refractive index ranging from about 1.53 to about 1.57.
